(19) United States
(12) Patent Application Publication
(10) Pub. No.: US 2025/0378630 A1
(43) Pub. Date: Dec. 11, 2025

(54) SYSTEMS AND METHODS FOR COMPLETING AN OBJECT SHAPE USING A GEOMETRIC PROJECTION AND DIFFUSION MODELS

(71) Applicant: Toyota Research Institute, Inc., Los Altos, CA (US)

(72) Inventors: Katherine Liu, Mountain View, CA (US); Sergey Zakharov, Menlo Park, CA (US); Dian Chen, Mountain View, CA (US); Takuya Ikeda, Tokyo (JP); Adrien David Gaidon, San Jose, CA (US); Rares A. Ambrus, San Francisco, CA (US)

(73) Assignees: Toyota Research Institute, Inc., Los Altos, CA (US); Toyota Jidosha Kabushiki Kaisha, Toyota-shi (JP)

(21) Appl. No.: 19/005,389

(22) Filed: Dec. 30, 2024

Related U.S. Application Data
(60) Provisional application No. 63/656,279, filed on Jun. 5, 2024.

(51) Int. Cl. G06T 15/20; G06T 7/50; G06T 7/70; G06T 15/08

(52) U.S. Cl. CPC G06T 15/20; G06T 7/50; G06T 7/70; G06T 15/08

(57) ABSTRACT

Systems, methods, and other embodiments described herein relate to deriving a geometric projection of an object shape using a normalized object reference frame (NORF) information and completing the object shape from the geometric projection through diffusion and triplanar processing. In one embodiment, a method includes estimating a NORF image and a NORF normal for an object from an image and noise using a NORF diffusion model, the object having incomplete data. The method also includes deriving a projection of the object from a point cloud using the NORF image and the NORF normal. The method also includes predicting a completed shape for the object from the projection and triplanar noise using a triplanar diffusion model.

### CROSS-REFERENCE TO RELATED APPLICATIONS

This application claims the benefit of U.S. Provisional Application No. 63/656,279, filed on Jun. 5, 2024, which is herein incorporated by reference in its entirety.

### TECHNICAL FIELD

The subject matter described herein relates, in general, to completing an object shape from an image, and, more particularly, to deriving a geometric projection of the object shape and completing the object shape from the geometric projection using a diffusion model.

### BACKGROUND

Systems understanding of a three-dimensional (3D) world is a task for applications ranging from augmented reality (AR) to robotics. For example, a vehicle detects objects within a driving environment by identifying features within image data and a distance from light detection and ranging (LIDAR) data. Despite progress in open-world image understanding and object detection, systems estimating a complete and accurate 3D geometry of objects in a scene having real-world measurements is an open problem. These systems may rely upon data from multiple cameras for inferring object geometries, thereby raising hardware costs and system complexity.

In certain approaches, perception systems completing objects within a 3D scene is an under-constrained problem. In particular, uncertainty in object shape from unseen parts and pose are sources of the problem. Systems encounter further uncertainty without assuming known geometry and tight constraints on object category. Therefore, systems predicting and completing 3D shapes face difficulties from data limitations and constraint frameworks.

### SUMMARY

In one embodiment, example systems and methods relate to deriving a geometric projection of an object shape using a normalized object reference frame (NORF) information and completing the object shape from the geometric projection through diffusion and triplanar processing. In various implementations, shape completion removes an assumption of a three-dimensional (3D) model based on a prior through estimations from limited observations. For example, systems train a model for shape priors with a ShapeNet dataset such that instances within a single class are aligned. Still, assumptions from alignment that benefit shape learning exhibit limits when completing an object in the wild due to an object category and pose being unknown, thereby reducing system robustness for demanding applications.

Therefore, in one embodiment, an estimation system decouples shape completion into two multi-modal distributions where one captures measurements projected into a NORF defined using a dataset and a second distribution models a prior over object geometries represented as triplanar neural fields. In particular, the estimation system can train conditional diffusion models separately for the two distributions that allows sampling of multiple hypotheses from a joint pose and shape distribution. Furthermore, the NORF maps an object to a normalized reference frame for pose and shape estimation without canonicalization demanding alignment to a coordinate system that is shared. As such, the estimation system expands predictions for general scenarios and varying datasets. In this way, the estimation system streamlines training and predictions of objects through the multi-modal and multi-stage diffusion distributions. Accordingly, the estimation system achieves real-world shape completion and metric scaling of an object from an image for single-shot and zero-shot predictions.

In various implementations, a first stage of the estimation system includes a NORF diffusion model that outputs a NORF image and a NORF normal for an object associated with an inputted image. Here, the object exhibits incomplete data after the NORF diffusion model diffuses the image with two-dimensional noise. The estimation system forms a point cloud using the NORF image and the NORF normal from identified data. In this way, a projection (e.g., 3D projection) of the object can be derived from the point cloud using the NORF image and the NORF normal. Furthermore, a second stage of the estimation system predicts a completed shape for the object from the projection and triplanar noise using a triplanar diffusion model. As such, the second stage of diffusion transforms the projection having the incomplete and identified data into a three-dimensional space through locating object surfaces using orthogonal planes. Accordingly, the estimation system predicts an object shape from a single image within a 3D space using multiple diffusion stages, thereby improving accuracy and robustness from using generalized data and increasing system applications.

In one embodiment, an estimation system for deriving a geometric projection of an object shape using NORF information and completing the object shape from the geometric projection through diffusion and triplanar processing is disclosed. The estimation system includes a memory storing instructions that, when executed by a processor, cause the processor to estimate a NORF image and a NORF normal for an object from an image and noise using a NORF diffusion model, the object having incomplete data. The instructions also include instructions to derive a projection of the object from a point cloud using the NORF image and the NORF normal. The instructions also include instructions to predict a completed shape for the object from the projection and triplanar noise using a triplanar diffusion model.

In one embodiment, a non-transitory computer-readable medium for deriving a geometric projection of an object shape using NORF information and completing the object shape from the geometric projection through diffusion and triplanar processing and including instructions that when executed by a processor cause the processor to perform one or more functions is disclosed. The instructions include instructions to estimate a NORF image and a NORF normal for an object from an image and noise using a NORF diffusion model, the object having incomplete data. The instructions also include instructions to derive a projection of the object from a point cloud using the NORF image and the NORF normal. The instructions also include instructions to predict a completed shape for the object from the projection and triplanar noise using a triplanar diffusion model.

In one embodiment, a method for deriving a geometric projection of an object shape using NORF information and completing the object shape from the geometric projection through diffusion and triplanar processing is disclosed. In one embodiment, the method includes estimating a NORF image and a NORF normal for an object from an image and noise using a NORF diffusion model, the object having incomplete data. The method also includes deriving a projection of the object from a point cloud using the NORF image and the NORF normal. The method also includes predicting a completed shape for the object from the projection and triplanar noise using a triplanar diffusion model.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of an estimation system that is associated with deriving a geometric projection of an object shape using normalized object reference frame (NORF) information and completing the object shape from the geometric projection through iterative diffusion.

FIG. 2 illustrates one embodiment of the estimation system of FIG. 1 using a NORF diffusion model and a triplanar diffusion model to complete an object shape and predict pose from an image.

FIGS. 3A and 3B illustrate embodiments of inputs/outputs from a two-stage diffusion model for projecting an object within an image and completing the object using triplanar diffusion.

FIG. 4 illustrates one embodiment of a method that is associated with predicting a completed shape for an object from a projection and a triplanar noise using a triplanar diffusion model.

### DETAILED DESCRIPTION

Systems, methods, and other embodiments associated with completing an object shape through deriving a geometric projection of the object shape using a normalized object reference frame (NORF) information and completing the object shape from the geometric projection with iterative diffusion and triplanar processing are disclosed herein. In various implementations, systems complete object shapes in a coordinate frame of a camera using a red-green-blue (RGB) image. Such systems can involve geometric assumptions that include assuming a known distance to an object, frontal views, etc. Regression-based systems also often assume the bounds of partially observed objects. Such approaches define bounds about an object for surface extraction, which can be brittle depending upon self-occlusion (e.g., a hidden feature, a hidden viewpoint, etc.). Furthermore, shape completion can involve eschewing known canonicalization (e.g., a standard form) for completing an object shape for various scenarios captured by an image. Regarding pose predictions, systems can involve assuming object geometry a priori on an instance or category level for template matching, inverse rendering, etc. Still, these systems encounter difficulties in the real world when mapping relationships between internal reference frames and metric observations using a single view resulting from sparse data and geometric assumptions that are lacking.

Therefore, in one embodiment, an estimation system jointly completes an object shape and predicts pose through a NORF diffusion model capturing a mapping between an image from a single view and a NORF using probabilities. The NORF diffusion model may diffuse a representation that is a partial point-cloud of an observed object from two-dimensional noise. In this way, the estimation system implicitly captures a pose and a partial shape of an object without assumptions for dataset canonicalization, thereby improving robustness with disparate data. A triplanar diffusion model learns a conditional distribution over complete objects that are represented as triplanar neural fields associated with a point cloud that is projected. For example, a point cloud includes data points in a 3D coordinate system that represents an external surface of an object. By learning a distribution over NORFs, the estimation system generates partial estimates for completing shapes in a normalized reference frame and accurately reprojects an object within a real-world scene. As such, the estimation system avoids brittle normalization of partial measurements into a fixed coordinate system. In one approach, the NORF and the triplanar diffusion models diffuse the image and NORF information using a diffusion probabilistic model (DPM), diffusion-denoising probabilistic model (DDPM), a model based on a UNET architecture, etc., that captures the rich multi-modal nature of the distributions. In this way, the estimation system outputs pairs of shapes and dense correspondences for placing a predicted object into a scene, thereby bridging probabilistic pose estimation and generative shape modeling. Another benefit is that the estimation system allows predictions without assuming a known 3D model, category, etc., about the object.

Regarding further details, in one embodiment, the estimation system executes shape completion having a decoupling of two multi-modal distributions. A first model captures how measurements project into a NORF defined by a dataset. A second model derives a prior over object geometries represented as triplanar neural fields. As such, the NORF and triplanar diffusion models train as separate conditional diffusion models for multiple distributions that allows sampling multiple hypotheses from joint pose and shape distributions. In this way, the estimation system jointly predicts pose and completes the shape of an object from a single image without demanding prior knowledge, thereby allowing both single-shot and zero-shot applications. Furthermore, the NORF is derived from less curated data and expansive datasets that relax demands for canonicalization requirements involving single-views and a common frame of reference per object category. As explained below, the reprojection and completion of the object shape involving diffusion can include modeling using triplanar grids and a point cloud observation that is incomplete for shape completion. Accordingly, the estimation system includes multiple diffusion models that decouple shape completion and pose prediction tasks for a shape from a single image within a 3D space that improves accuracy and robustness from using generalized data.

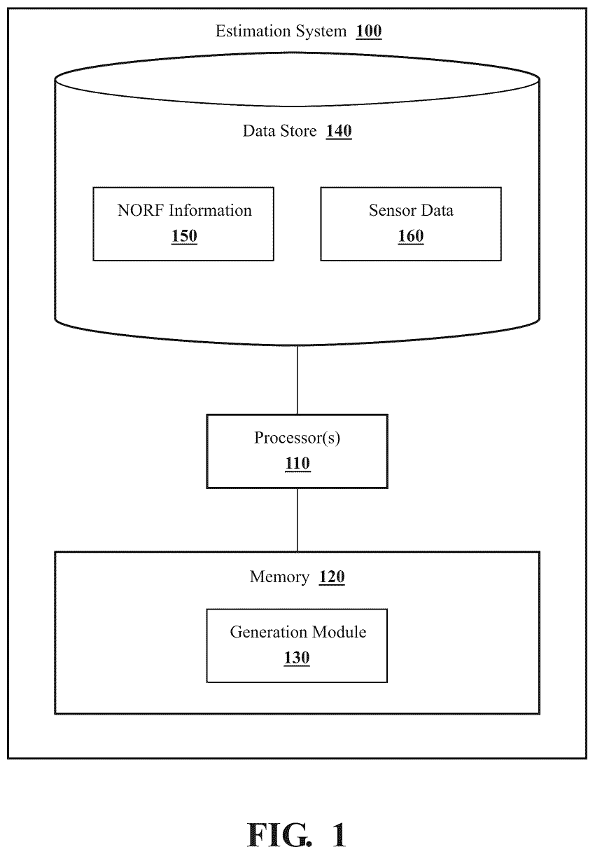

Referring to FIG. 1, one embodiment of an estimation system that is associated with deriving a geometric projection of an object shape using NORF information and completing the object shape from the geometric projection through iterative diffusion is illustrated. For simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, estimation system 100 is implemented to perform methods and other functions as disclosed herein relating to completing an object shape through deriving a geometric projection of the object shape using NORF information and completing the object shape from the geometric projection with iterative diffusion and triplanar processing.

In one embodiment, the estimation system 100 includes a memory 120 that stores an a generation module 130. The memory 120 is a random-access memory (RAM), a read-only memory (ROM), a hard-disk drive, a flash memory, or other suitable memory for storing the generation module 130. The generation module 130 is, for example, computer-readable instructions that when executed by the processor(s) 110 cause the processor(s) 110 to perform the various functions disclosed herein.

In various implementations, the generation module 130 controls sensors to provide the data inputs in the form of sensor data 160, such as a RGB, a RGB-depth (RGB-D), etc., image from a camera. Furthermore, the generation module 130 can undertake various approaches to fuse data from multiple sensors when providing the sensor data 160 and/or from sensor data acquired over a wireless communication link. Thus, the sensor data 160, in one embodiment, represents a combination of perceptions acquired from multiple sensors.

Moreover, in one embodiment, the estimation system 100 includes a data store 140. In one embodiment, the data store 140 is a database. The database is, in one embodiment, an electronic data structure stored in the memory 120 or another data store and that is configured with routines that can be executed by the processor(s) 110 for analyzing stored data, providing stored data, organizing stored data, and so on. Thus, in one embodiment, the data store 140 stores data used by the generation module 130 in executing various functions. In one embodiment, the data store 140 includes the sensor data 160 along with, for example, metadata that characterize various aspects of the sensor data 160. For example, the metadata can include location coordinates (e.g., longitude and latitude), relative map coordinates or tile identifiers, time/date stamps from when the separate sensor data 160 was generated, and so on. In one embodiment, the data store 140 further includes NORF information 150 representing a coordinate framework that is normalized and yet applies to various objects from a limited viewpoint. In this way, the NORF information 150 relaxes demands for canonicalization and shared coordinate systems for object categories, thereby applying to general scenarios and a wider array of datasets.

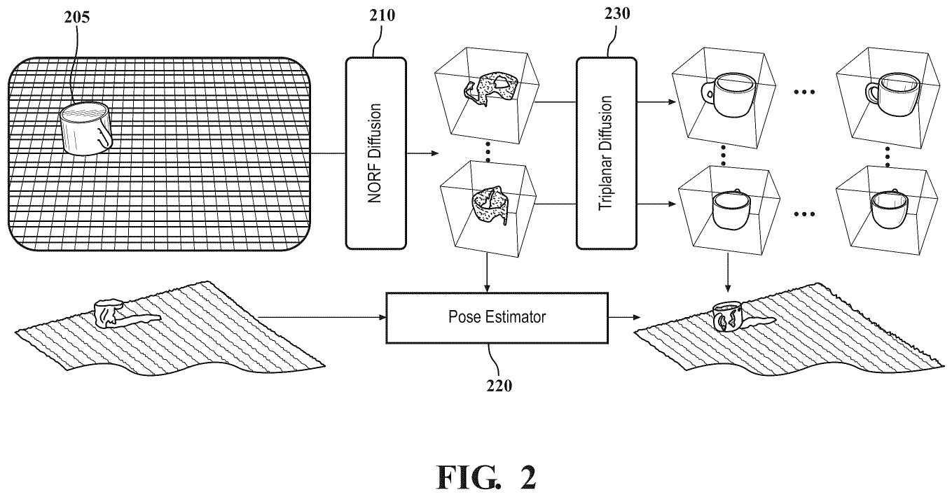

Now turning to FIG. 2, one embodiment of the estimation system 100 of FIG. 1 using a NORF diffusion model and a triplanar diffusion model for completing an object shape and predicting pose from an image is illustrated. In FIG. 2, the estimation system 100 outputs various hypotheses of object 205 (e.g., a cup) found within a single image and observation. A pose can reflect real orientation and position of the object 205 within a scene. In one approach, the estimation system 100 includes instructions that cause the processor 110 to estimate a NORF image and a NORF normal for the object 205 from an image and noise by a NORF diffusion model 210 associated with detection. Here, the object 205 can have incomplete data during detection. Furthermore, the estimation system 100 can derive projection of the object 205 from a point cloud using the NORF image and the NORF normal. In one approach, the generation module 130 predicts a completed shape for the object 205 from the projection and triplanar noise using a triplanar diffusion model 230. As explained below, registration 330 can estimate pose using the NORF map and a depth image that is calibrated through observations. In this way, the estimation system can complete a shape of an object and predict pose using a multi-modal and multi-probabilistic form that increases efficiency.

Moreover, shape completion tasks can involve deterministic, probabilistic, etc., computations. A deterministic model predicts a single estimate given an observation. A probabilistic technique involves generative tasks for shape completion by modeling distributions over shapes, rather than providing a single shape estimate. A system can complete an object shape using an image as a condition and output plausible 3D completions without predicting and incorporating a pose for the object. However, estimating real-world position and scale of an object from an image demands pose and shape predictions. Therefore, the estimation system 100 computes the pose of an object depending upon the application, computing resources, a viewpoint, etc.

In one embodiment, the estimation system 100 jointly estimates a pose x ∈ SE (3) and a shape z of the object 205 using an observation. For example, the observation is a single cropped, segmented RGB-D observation I ∈ [symbol] ^{dxdx4} and d is the crop resolution. The estimation system 100 models a joint probability distribution between shape and pose given the observation, p (x, z|I) without a priori knowledge. Regarding scaling and predicting a metric pose in the real world, the estimation system 100 relies upon a depth measurement initially acquired from the RGB-D image. In one approach, shape completion does not rely upon depth values acquired from the RGB-D image when pose and real spatial measurements are irrelevant for a task. Furthermore, improving sampling efficiency involving a single image and a multi-modal space that is vast can encompass replacing x with an image-like map m ∈ [symbol] ^{dxdx3} outputted by the NORF diffusion model 210. This allows projecting normalized 3D coordinates of object points that are visible to a NORF map representing a camera reference frame.

In one approach, the NORF map includes a dense pixel-to-3D association that improves pose predictions within a scene when pose estimator 220 recovers x from m. For instance, the estimation system 100 and/or pose estimator 220 can recover x by implementing a procrustes algorithm, a gradient descent, etc., when measured depth points are available. As further explained below, the estimation system 100 can register a lifted representation of the object 205 outputted by the NORF diffusion model 210. The lifted representation may be associated with a point cloud that is incomplete about the object 205. The estimation system 100 can subsequently estimate a metric pose of the object 205 within a scene using inputted depth and one of multiple hypotheses about the projection associated with the lifted representation. As previously explained, the inputted depth is part of a RGB-D image representing a single view of the object.

In another example, computations by the NORF diffusion model 210 and the triplanar diffusion model 230 involve forming a joint probability over object geometry and pose p (z, m|I). Besides pose estimation, m also provides a point cloud having a partial observation about the object surface for completing a shape. In this way, the estimation system 100 disentangles joint reasoning about pose and shape from two distributions: (1) the observed surface points in a normalized object reference frame m given the image I; and (2) the object geometry z given the partial observation in m:

$$p ( z , m \vert 1 ) = p ( z \vert m ) p ( m \vert I ) . \qquad Equation ( 1 )$$

In Equation (1), an assumption is that m provides the necessary information to model z. In another approach, the estimation system 100 approximates both conditional distributions using a DDPM and learns two models

$${ϵ}_{θ}^{m} and {ϵ}_{θ}^{z} .$$

### Here,

$${ϵ}_{θ}^{m} and {ϵ}_{θ}^{z}$$

can be based-on a UNET architecture, a score-based generative model using noise, a latent diffusion model (LDM), etc. In this way, the two models can form p (m|I) and p (z|m), respectively, thereby allowing sampling from the joint (pose, shape) distribution that increases accuracy while decreasing computation time.

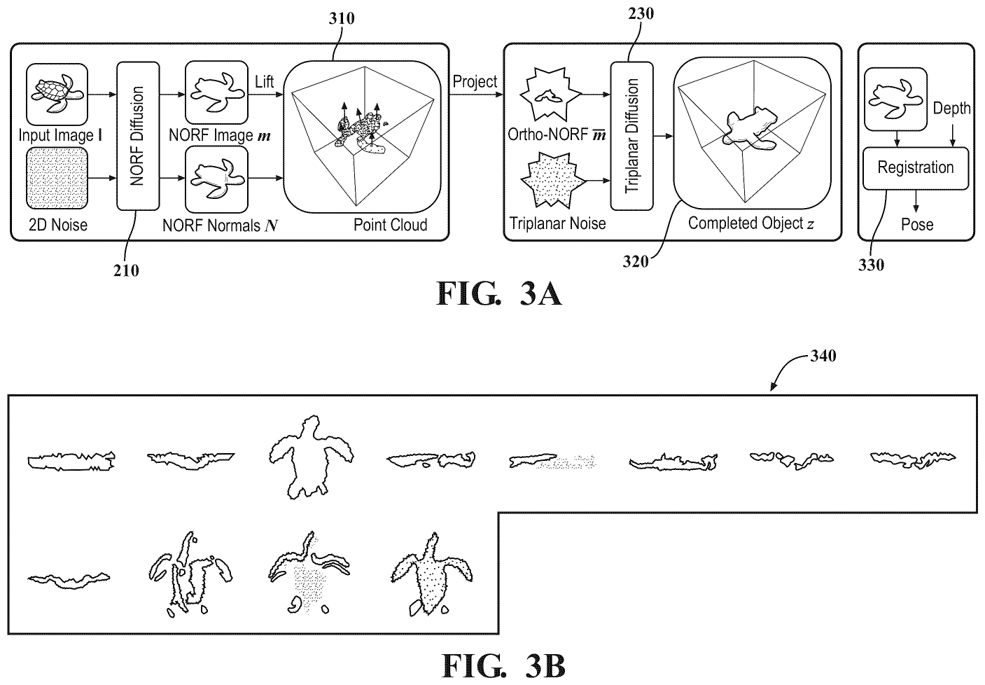

FIGS. 3A and 3B illustrate embodiments of inputs/outputs of a two-stage diffusion model for projecting an object within an image and completing the object using triplanar diffusion. The NORF diffusion model 210 denoises inputs through generative tasks iteratively using point cloud 310 having incomplete information, thereby allowing diverse predictions for pose and shape. Here, the pose can reflect the real orientation and position of the object within a scene while the shape represents form, contours, surface features, etc., about the object. A diffusion model can assume a forward noising process through iteratively adding noise that is normally distributed to the state u: q (uₜ|uₜ₋₁)= [symbol] (\sqrt{1−Bₜ}uₜ₋₁, βₜI). The noise can be 2D noise generated by a random function. Here, βₜ changes according to a predefined variance schedule. For a backwards “denoising” process, a function to can train to predict the amount of unscaled noise ϵ˜ [symbol] (0, I) in a given noisy input uₜ, i.e., to minimize a noise-matching objective:

$$ℒ ( θ ) = {𝔼}_{t , {u}_{0} , ϵ} [ {‖ ϵ - {ϵ}_{θ} ( {u}_{t} , t ) ‖}^{2} ] . \qquad Equation ( 2 )$$

Given a denoising function that is trained, the estimation system 100 can sample a tensor from random noise iteratively for denoising. Here, a tensor can be generalized scalars, vectors, and matrices that describe physical and transformative features about an object in multiple dimensions. In another embodiment, a diffusion model can model a conditional distribution using direct conditioning, classifier-free guidance, etc. The estimation system 100 can approximate both p (z|m) and p (m|I) with diffusion models and implement classifier-free guidance to generate samples from p (z|m). As explained below, classifier-free guidance can approximate sampling from the conditional probability distribution involving multi-modal distributions for shape completion.

In various implementations, the NORF diffusion model 210 can map an image acquired from a camera as a condition and inputted to a reference frame having a point cloud representation. This can involve sampling segmented portions of the image within the reference frame using the NORF diffusion model 210. In one approach, a NORF image arranges points of an object within a finite and unitless shape (e.g., a cubical coordinate system) such that an object having different real dimensions lies in the shape. This can include setting a NORF value of a background pixel at the bottom (e.g., bottom left corner) of the unitless shape and normalizing the object to slightly smaller than the unitless shape. In this way, the estimation system 100 can filter predicted point cloud values exhibiting excessive noise as the predictions at the edges of a segmented object can be noisier. Thus, the NORF diffusion model 210 converts XYZ coordinate values into RGB values for de-noising with 2D noise over various values and shapes.

Furthermore, the NORF diffusion model 210 can generate and output the point cloud 310 that is incomplete by lifting an outputted NORF image. Here, lifting can involve transforming an object within the image from two-dimensions to three-dimensions using the image and the NORF normal. Additionally, the point cloud 310 can represent a correspondence between pixels of the image and 3D coordinate points. A projection of the object may also be associated with information from the point cloud 310. In this way, the estimation system 100 can position the object within an actual scene using the 3D coordinate points upon predicting pose about the object.

As further explained below, the NORF diffusion model 210 outputs a NORF image m associated with a NORF position map. Pixel colors representing different 3D positions in a reference frame can be included in the NORF position map. Furthermore, the NORF diffusion model 210 can output a NORF normal map N having a pixel value representing a surface normal of the object from an observed point in a reference frame that is normalized.

In an additional embodiment, the NORF diffusion model 210 building and outputting NORF maps includes assuming a dataset of posed RGB-D images built from 0 object models. Here, an object lies within a unit cube centered at the origin (i.e., object-centric) for a 3D coordinate system. The estimation system 100 can project a visible surface associated with the object into a posed camera to obtain a NORF position map mₓ ∈ [symbol] ^{dxdx3} that is positionally aligned with an inputted RGB-D. The NORF position map can be an image-like quantity where a pixel color value indicates a 3D location within the NORF. This allows extracting the point cloud 310 that is 3D from the NORF information 150. As previously explained, in this way the estimation system 100 can also predict a 3D pose for a segmented depth image since an observed surface point corresponds with a point in the NORF. The estimation system 100 and/or the NORF diffusion model 210 also build a NORF normal map m_{N} ∈ [symbol] ^{dxdx3} having pixel values representing a surface normal of an observed point. Together mₓ and m_{N} can be structures that form the NORF measurement m.

Constructing a NORF map can include forming a tuple having image information, a normal that is transformed into the NORF, and a NORF map that is partially completed represented as {(Iᵢ, Nᵢ, mᵢ)}. The estimation system 100 includes a normal N rather than depth inputs directly. This approach avoids brittleness in normalizing an image having depth values that are arbitrary.

When the NORF diffusion model 210 is a DPM (e.g., a DDPM), training can involve using the NORF map m as a state, and the RGB image I and normals map N for model conditioning using representation:

$$ℒ ( θ ) = {𝔼}_{t , ( {m}_{0} , I , N ) , ϵ} [ {‖ ϵ - {ϵ}_{θ}^{m} ( {m}_{t} , t , I , N ) ‖}^{2} ] . \qquad Equation ( 3 )$$

For example, the objective function using Equation (3) for training

$${ϵ}_{θ}^{m}$$

can also involve data augmentation such as randomly down-sampling the input conditioning and resizing back to the intended resolution with a probability of X %. This can also include randomly rotating the input conditioning predictions associated with a probability of Y %. In one approach, the training involves the NORF diffusion model 210 acquiring synthetic data and testing on challenging real-world estimation tasks. This can include inputting normals along with RGB images. In this way, the estimation system 100 trains to sample from

$${ϵ}_{θ}^{m}$$

for approximating a point cloud of partial observations in the normalized object reference frame denoising a random 2D noise conditional upon the input image I. As such, a partial observation can be as p (m|I) and represent multiple hypotheses generated by the NORF diffusion model 210 about an object within an inputted RGB image.

In FIG. 3A, a second stage includes the triplanar diffusion model 230 that receives a projection of an object represented as a triplanar neural field associated with the point cloud 310 having partial data. Furthermore, the triplanar diffusion model 230 denoises random triplanar noise for diffusion and shape completion. Here, the triplanar neural field can represent a prior of object shapes and the triplanar neural field including signed distance fields (SDF). In particular, the object can be represented by a triplanar latent Z ∈ [symbol] ^{3×2}^{^{p}}^{×2}^{^{p}}^{×n}, where n is the dimension of the latent and p is a detail level. In one approach, the triplanar representation allows for continuous neural fields to be represented as three orthogonal 2^{p}×2^{p} feature planes. Although examples describe three feature planes, the estimation system 100 can utilize any number of feature planes for outputting completed object 320. The triplanar diffusion model 230 can query the signed distance of an arbitrary point p ∈ [symbol] ³ by projecting the coordinate onto three orthogonal planes. Upon trilinear interpolation per plane, the triplanar diffusion model 230 concatenates the resulting features to obtain the latent for the coordinate, i.e., z̅ₚ=ω(p,z), where z̅ ∈ [symbol] ³^{ₙ}.

Moreover, the estimation system 100 learns a decoder ξ such that fₚ=ξ(z̅ₚ) for computing a final signed distance value fₚ. Here, a dataset is assumed to include O objects that can include one or more RGB-D renderings for training

$${ϵ}_{θ}^{m} and {ϵ}_{θ}^{z} .$$

An object can be represented by an SDF point cloud tuple {(s₀, d₀) . . . (s_{M}_{ᵢ}, d_{M}_{ᵢ})}, which is a sample of Mᵢ 3D points s ∈ [symbol] ³ coupled with a distance d ∈ [symbol] ³ from the object surface. The estimation system 100 can optimize and train over the set of triplanar latents [symbol] ={z₀, . . . . z_{O}} and a parameter set of the decoder & associated with objects to minimize a reconstruction loss (e.g., a L1 loss). The reconstruction loss can be combined with a total variation (TV) term summed over one or more of feature planes (e.g., three planes):

$$Equation ( 4 )$$

$$ℒ ( 𝒵 , ξ ) = {\sum }_{i = 0}^{i = O} {\sum }_{j = 0}^{j = {M}_{i}} \vert ξ ( ω ( {s}_{j} , {z}_{i} ) ) - {d}_{j} \vert + {α}_{TV} {\sum }_{i = 0}^{i = O} TV ( {z}_{i} ) .$$

Upon optimizing a triplane set, the estimation system 100 pairs optimized triplanes and point clouds with normals in the NORF for training the triplanar diffusion model 230. Furthermore, the estimation system 100 can rearrange a triplanar representation into image-like tensors of dimension

$${z}^{′} ∈ {ℝ}^{{2}^{p} \times {2}^{p} \times 3 n} .$$

This can allow 2D diffusion for the model

$${ϵ}_{θ}^{z}$$

to complete a snape for an object.

In one approach, outputting the completed object 320 includes assuming that NORF predictions are already in a normalized reference frame, thereby avoiding pre-prediction normalization that is brittle and overly coarse. Furthermore, aligning shape completion in stage two with NORF information from stage one can involve the estimation system 100 voxelizing a partial point cloud m into an occupancy grid with side dimension 2^{p+1}. This can involve maintaining an average normal value for occupied cells, orthogonally projecting the values onto multiple planes (e.g., three), and generating measurements aligned with a triplanar representation. In this manner, a projection of the point cloud 310 exhibits orthogonal properties after voxelizing and tracing 3D points of the object (e.g., a turtle).

Regarding FIG. 3B, a conditioning tensor associated with an object 340 (i.e., a turtle) before pixel unshuffling from various viewpoints is illustrated. Here, pixel unshuffling further reduces a spatial dimension of the conditioning by a Z amount (e.g., half), thereby simplifying computations. After rearranging into image-like tensors, the estimation system 100 can build the ortho-NORF

$$\overline{m} ∈ {ℝ}^{{2}^{p} \times {2}^{p} \times 48}$$

representing a point cloud with normals having partial information and orthogonally projected into a triplanar space. For instance, the ortho-NORF is an observation of surface points for an object observed from the northern viewpoint.

During inference, the estimation system 100 filters noisy points from m predictions before projecting to m̅. As such, Equation (2) becomes the following when adapting for shape completion using diffusion during training:

$$ℒ ( θ ) = {𝔼}_{t , ( {z}^{′} , \overline{m} ) , {ϵ}_{t}} [ {‖ {ϵ}_{t} - {ϵ}_{θ}^{z} ( {z}_{t}^{′} , t , \overline{m} ) ‖}^{2} ] . \qquad Equation ( 5 )$$

In Equation (5), the objective function includes a state that is a triplane z′ from [symbol] . The conditioning m̅ represents an ortho-NORF of a point cloud that is projected. At inference time, the estimation system 100 can sample from p (z|m) using the trained

$${ϵ}_{θ}^{z}$$

for outputting the completed object 320 having full shape information. As such, the NORF diffusion model 210 and the triplanar diffusion model 230 are probabilistic models that train to individually output multiple hypotheses about one of the projection and the completed object 320, respectively. The projection can include partial shape and pose information. Furthermore, the projection has orthogonal NORF data from voxelizing and tracing three-dimensional points of the point cloud 310 that is incomplete. As such, the triplanar diffusion model 230 diffuses ortho-normal data derived from the projection using triplanar noise. If pose computations are unnecessary, the output of the triplanar diffusion model 230 can complete a shape that includes a geometry of the object in a unitary shape. In this way, the estimation system 100 and/or the triplanar diffusion model 230 can extract an accurate and complete form of the object from a triplanar representation.

In another example, the estimation system 100 normalizes the input m per channel to have a standard deviation and limits clip values to a range. For example, the standard deviation is 0.2, 0.3, etc., from an object surface and the clip values are [−1, 1]. In this way, the estimation system 100 can improve accuracy and computational efficiency for completing shapes and estimating pose through normalization and limiting data scope.

Further details about shape completion are as follows. The estimation system 100 acquires an RGB-D image with a segmented object during inference and the NORF diffusion model 210 implements

$${ϵ}_{θ}^{m}$$

for sampling a NORF map m. Here,

$${ϵ}_{θ}^{m}$$

training on datasets having human-generated 3D models for sampling a NORF map m can exhibit a patterned structure and natural alignment of object data without intra-class canonicalization (e.g., coordinate standardization). As such, the estimation system 100 using these patterns can avoid optimizing triplanes online for objects in arbitrary poses through shapes being completed in a common reference frame. Furthermore, the NORF map m becomes a condition and a sample for completing an object by the trained model

$${ϵ}_{θ}^{z}$$

using diffusion of tripolar noise and extracting the object from a triplanar representation. This allows streamlining pose and shape estimation through a multi-stage (e.g., 2) manner. In this way, the estimation system 100 can identify an explicit pose x and extract a surface about an object from sampled values of m and z and place the object into a scene having a metric scale efficiently.

Moreover, the estimation system 100 can generate multiple hypotheses from the joint distributions of pose and shape through iterative sampling or batch processing of predicted outputs. In one approach, the estimation system 100 feeds forward predicted outputs for shape and pose without feedback and generates the multiple hypotheses about the object from a single image through diffusion. For example, a batch can include five partial point clouds sampled for five shapes. This in turn can form 25 hypotheses about the object and include optional corresponding poses. In this way, the estimation system 100 accurately completes a shape for an object, sizes the object within a scene using real-world coordinates, and positions the object within the scene for single-shot applications.

In various implementations, the estimation system 100 selects a hypothesis from multiple hypotheses generated using scores for a pose such that the score is computed by the registration 330. Here, the registration 330 may take inputs for NORF image m and/or the point cloud 310 along with depth acquired from an RGB-D image for outputting a pose. Accordingly, the estimation system 100 can have a final output for a shape and accurately position an object within a metric world for downstream tasks (e.g., automated driving, generative animation, etc.).

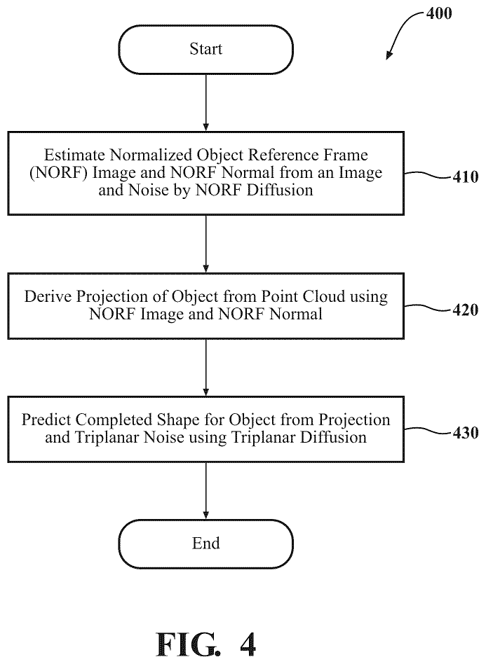

Now turning to FIG. 4, one embodiment of a method 400 that is associated with predicting a completed shape for an object from a projection and a triplanar noise using a triplanar diffusion model is illustrated. FIG. 4 illustrates a flowchart of the method 400 that is associated with completing an object shape through deriving a geometric projection of the object shape using NORF information and completing the object shape from the geometric projection with iterative diffusion and triplanar processing. Method 400 will be discussed from the perspective of the estimation system 100 of FIG. 1. While the method 400 is discussed in combination with the estimation system 100, it should be appreciated that the method 400 is not limited to being implemented within the estimation system 100 but is instead one example of a system that may implement the method 400.

In various implementations, the method 400 includes a process where a NORF diffusion model is associated with a first probabilistic distribution of an object within a reference frame in a first stage. As previously explained, outputs of the NORF diffusion model can be conditional upon the image involve using noise that is 2D for diffusion. A triplanar diffusion model is associated with a second probabilistic distribution of the object along multiple orthogonal planes in a second stage. As such, the method 400 disentangles shape completion from pose for simplifying computations. In this way, the triplanar diffusion model is conditioned with an ortho-NORF representation of the image in a triplanar space and triplanar noise for accurately and efficiently completing a shape, surface, etc., of the object.

At 410, the estimation system 100 estimates a NORF image and a NORF normal from an image and noise using a NORF diffusion model for completing an object shape. For example, the NORF image includes mapped points of an object arranged within finite and unitless shape (e.g., a cubical coordinate system) such that object having different real dimensions lies in the shape. Furthermore, the NORF diffusion model can train as a conditional distribution using a DPM to generate the NORF image as a mapping through diffusing the image with 2D noise. As such, the NORF diffusion model outputs a NORF image as a position map that is color-coded. For instance, pixel colors representing different 3D positions and locations in a reference frame are included in the NORF position map. As such, the NORF diffusion model is trained to convert XYZ coordinates into RGB values for diffusion involving denoising with 2D noise over various values and shapes. Furthermore, the NORF diffusion model can output a NORF normal map having a pixel value representing a surface normal of the object from an observed point.

At 420, the estimation system 100 derives a projection of the object from a point cloud using the NORF image and the NORF normal. In one approach, the projection is associated with an incomplete point cloud that the NORF diffusion model generated and output by lifting an outputted the NORF image. The projection can include partial shape and pose information after lifting and tracing 3D points of the object. As previously explained, lifting can involve transforming an object within the image from two-dimensions to three-dimensions using the image and the NORF normal. Furthermore, the projection can involve maintaining an average normal value for occupied cells in a coordination system, orthogonally projecting the values onto multiple planes (e.g., three) using the NORF normal. In this way, the estimation system 100 can generate measurements aligned with a triplanar representation for additional tasks to complete the object.

At 430, the generation module 130 predicts a completed shape for the object from the projection and triplanar noise using a triplanar diffusion model. Here, the triplanar diffusion model can diffuse ortho-normal data derived from the projection starting from triplanar noise. For example, the triplanar diffusion model receives a projection of an object represented as a triplanar neural field associated with the point cloud having partial data and triplanar noise as inputs for diffusion and shape completion. The triplanar neural field can represent a prior of object shapes and the triplanar neural field including SDF. In one approach, the estimation system 100 can build the ortho-NORF that is a point cloud with normal having partial information and orthogonally projected into a triplanar space after rearranging into image-like tensors. For instance, the ortho-NORF is an observation of surface points for an object observed from the northern viewpoint.

Moreover, the triplanar diffusion model can query the signed distance of an arbitrary point by projecting the coordinate onto three orthogonal planes. In one approach, upon trilinear interpolation per plane, the triplanar diffusion model concatenates the resulting data and obtains the latent for a coordinate. This can include the estimation system 100 filtering noisy points from predictions before projecting the point cloud. Furthermore, the estimation system 100 can sample from the ortho-NORF diffused using triplanar noise and a partial object shape using the triplanar diffusion model. The output can be multiple versions of a completed object that includes a geometry of the object in a unitary shape. As such, the NORF diffusion model and the triplanar diffusion model are a probabilistic model that train to individually output multiple hypotheses about one of the projection and the completed object.

In various implementations, the NORF image is a map that includes a dense pixel-to-3D association for improving pose predictions within a scene. For example, the estimation system 100 and/or a pose estimator recovers pose by implementing a procrustes algorithm, a gradient descent, etc., when measured depth points are available. As previously explained, the estimation system 100 can register a lifted representation of the object outputted by the NORF diffusion model using scoring. The estimation system 100 can subsequently predict a metric pose of the object within a scene using inputted depth and multiple hypotheses about the projection associated with the lifted representation. As previously explained, the inputted depth is part of an RGB-D image that can represent a single view of the object. As such, a completed shape can reflect metric dimensions by integrating the metric pose. Accordingly, the estimation system 100 predicts an object shape from a single image within a 3D space and exhibiting metric scaling from the real-world using multiple diffusion stages, thereby improving efficiency, data robustness, and accuracy.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. An estimation system comprising:
a memory storing instructions that, when executed by a processor, cause the processor to:
estimate a normalized object reference frame (NORF) image and a NORF normal for an object from an image and noise using a NORF diffusion model, the object having incomplete data;
derive a projection of the object from a point cloud using the NORF image and the NORF normal; and
predict a completed shape for the object from the projection and triplanar noise using a triplanar diffusion model.

2. The estimation system of claim 1 further including instructions to:
register a lifted representation of the object outputted by the NORF diffusion model, the lifted representation associated with the point cloud that is incomplete about the object; and
estimate a metric pose of the object within a scene using inputted depth and one of multiple hypotheses about the projection associated with the lifted representation, the inputted depth is part of the image and the image represents a single view.

3. The estimation system of claim 1 further including instructions to:
map the image by the NORF diffusion model to a reference frame, wherein the image is segmented;
sample the image within the reference frame using the NORF diffusion model;
generate the point cloud that is incomplete by lifting the NORF image from two-dimensions to three-dimensions using the image and the NORF normal, wherein the point cloud is associated with a correspondence between pixels of the image and three-dimensional (3D) coordinate points and the projection includes information from the point cloud; and
position the object in an actual scene using the 3D coordinate points.

4. The estimation system of claim 1, wherein the instructions to predict the completed shape further include instructions to:
diffuse ortho-normal data derived from the projection using the triplanar noise by the triplanar diffusion model, wherein the ortho-normal data is a condition; and
extract the object from a triplanar representation by the triplanar diffusion model.

5. The estimation system of claim 1, wherein the instructions to predict the completed shape further include instructions to:
represent the object as a triplanar neural field using the projection of the point cloud having partial information, and the triplanar neural field represents a prior of object shapes and the triplanar neural field including signed distance fields.

6. The estimation system of claim 1, wherein the completed shape includes a geometry of the object.

7. The estimation system of claim 1, wherein:
the NORF image is associated with a NORF position map having pixel colors representing different 3D positions in a reference frame; and
the NORF image is associated with NORF normal map having a pixel value representing a surface normal of the object from an observed point.

8. The estimation system of claim 1, wherein:
the NORF diffusion model and the triplanar diffusion model are a diffusion denoising probabilistic model that individually output multiple hypotheses about one of the projection and the completed shape, and the projection includes partial shape and pose information; and
the projection has orthogonal NORF data from voxelizing and tracing three-dimensional points of the point cloud that are incomplete.

9. The estimation system of claim 1, wherein:
the NORF diffusion model is associated with a first probabilistic distribution of the object within a reference frame in a first stage;
the triplanar diffusion model is associated with a second probabilistic distribution of the object along multiple orthogonal planes in a second stage;
the NORF diffusion model is conditioned with the image and the noise that is two-dimensional (2D); and
the triplanar diffusion model is conditioned with an ortho-NORF representation of the image in a triplanar space and the triplanar noise.

10. A non-transitory computer-readable medium comprising:
instructions that when executed by a processor cause the processor to:
estimate a normalized object reference frame (NORF) image and a NORF normal for an object from an image and noise using a NORF diffusion model, the object having incomplete data;
derive a projection of the object from a point cloud using the NORF image and the NORF normal; and
predict a completed shape for the object from the projection and triplanar noise using a triplanar diffusion model.

11. The non-transitory computer-readable medium of claim 10 further including instructions to:
register a lifted representation of the object outputted by the NORF diffusion model, the lifted representation associated with the point cloud that is incomplete about the object; and
estimate a metric pose of the object within a scene using inputted depth and one of multiple hypotheses about the projection associated with the lifted representation, the inputted depth is part of the image and the image represents a single view.

12. A method comprising:
estimating a normalized object reference frame (NORF) image and a NORF normal for an object from an image and noise using a NORF diffusion model, the object having incomplete data;
deriving a projection of the object from a point cloud using the NORF image and the NORF normal; and
predicting a completed shape for the object from the projection and triplanar noise using a triplanar diffusion model.

13. The method of claim 12 further comprising:
registering a lifted representation of the object outputted by the NORF diffusion model, the lifted representation associated with the point cloud that is incomplete about the object; and
estimating a metric pose of the object within a scene using inputted depth and one of multiple hypotheses about the projection associated with the lifted representation, the inputted depth is part of the image and the image represents a single view.

14. The method of claim 12 further comprising:
mapping the image by the NORF diffusion model to a reference frame, wherein the image is segmented;
sampling the image within the reference frame using the NORF diffusion model;
generating the point cloud that is incomplete by lifting the NORF image from two-dimensions to three-dimensions using the image and the NORF normal, wherein the point cloud is associated with a correspondence between pixels of the image and three-dimensional (3D) coordinate points and the projection includes information from the point cloud; and
positioning the object in an actual scene using the 3D coordinate points.

15. The method of claim 12, wherein predicting the completed shape further includes:
diffusing ortho-normal data derived from the projection using the triplanar noise by the triplanar diffusion model, wherein the ortho-normal data is a condition; and
extracting the object from a triplanar representation by the triplanar diffusion model.

16. The method of claim 12, wherein predicting the completed shape further includes:
representing the object as a triplanar neural field using the projection of the point cloud having partial information, and the triplanar neural field representing a prior of object shapes and the triplanar neural field including signed distance fields.

17. The method of claim 12, wherein the completed shape includes a geometry of the object.

18. The method of claim 12, wherein:
the NORF image is associated with a NORF position map having pixel colors representing different 3D positions in a reference frame; and
the NORF image is associated with NORF normal map having a pixel value representing a surface normal of the object from an observed point.

19. The method of claim 12, wherein:
the NORF diffusion model and the triplanar diffusion model are a diffusion denoising probabilistic model that individually output multiple hypotheses about one of the projection and the completed shape, and the projection includes partial shape and pose information; and
the projection has orthogonal NORF data from voxelizing and tracing three-dimensional points of the point cloud that are incomplete.

20. The method of claim 12, wherein:
the NORF diffusion model is associated with a first probabilistic distribution of the object within a reference frame in a first stage;
the triplanar diffusion model is associated with a second probabilistic distribution of the object along multiple orthogonal planes in a second stage;
the NORF diffusion model is conditioned with the image and the noise that is two-dimensional (2D); and
the triplanar diffusion model is conditioned with an ortho-NORF representation of the image in a triplanar space and the triplanar noise.
